(19) United States
(12) Patent Application Publication
(10) Pub. No.: US 2022/0002538 A1
(43) Pub. Date: Jan. 6, 2022

(54) Tackifier for rubber compositions

(71) Applicant: BASF SE, Ludwigshafen am Rhein (DE)

(72) Inventors: Miran YU, Ludwigshafen (DE); Guenter Scherr, Ludwigshafen (DE); Markus Jegelka, Ludwigshafen (DE); Frank Reuter, Ludwigshafen (DE)

(73) Assignee: BASF SE, Ludwigshafen am Rhein (DE)

(21) Appl. No.: 17/309,304

(22) PCT Filed: Nov. 19, 2019
(86) PCT No.: PCT/EP2019/081733

§ 371 Date: May 18, 2021

(30) Foreign Application Priority Data
Nov. 28, 2018 (EP) 18208900.3

(51) Int. Cl. C08L 65/02; C08L 9/06

(52) U.S. Cl. CPC C08L 65/02; C08L 2205/03; C08L 2205/06; C08L 9/06

(57) ABSTRACT

A tackifier contains a resin with repeating units of formula I

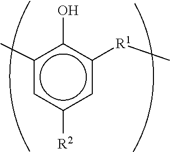

wherein R¹ is a linear or branched alkylene group with 1 to 10 carbon atoms and R² is a linear or branched, saturated or unsaturated aliphatic hydrocarbon group with up to 20 carbon atoms. The tackifier also contains an amino resin with on average at least two hydroxy or ether groups per molecule.

Object of the present invention is a tackifier comprising a resin with repeating units of formula I

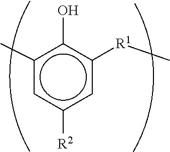

wherein R¹ is a linear or branched alkylen group with 1 to 10 carbon atoms and R² is a linear or branched, saturated or unsaturated aliphatic hydrocarbon group with up to 20 carbon atoms and

an amino resin with on average at least two hydroxy or ether groups per molecule.

A well-known tackifier according to formula I is Koresin®, a resin sold by BASF, described for example in DE 734 493. Koresin® is added as tackifier to rubber compositions for the manufacturing of rubber articles, which are notably tires for cars or trucks. Koresin® is obtained by reacting para tertiary butyl phenol with acetylene. Further tackifiers are, for example, formaldehyde resins that are produced by reacting phenol derivatives with formaldehyde. From WO 2018/104151 it is known to add certain plasticizers to such tackifiers resulting in a tackifier composition with reduced glass transition point and good performance properties in rubber.

Such tackifiers may comprise a residual amount of the phenol derivative used as starting material, for example para tertiary butyl phenol in case of Koresin. For the performance in technical applications and for environmental protection, a tackifier with a low content of volatile contents is desired. Unpublished European patent application No. 18154940.3 (INV 171459) describes the removal of volatile compounds from tackifier compositions in a thin film evaporator.

It was an object of the invention to provide a process for the reduction of volatile compounds in Koresin and other tackifiers. The process should be very efficient. The portion of volatile compounds should be reduced significantly. Costs for investment should be avoided, if possible. There should be no major negative effect on the performance properties of the tackifier. Notably the adhesion of rubber compositions comprising the tackifier should be as good as possible.

Accordingly, the tackifier defined above and rubber compositions comprising the tackifier have been found.

To the Resin with Repeating Units of Formula I

The resin comprises repeating units of formula I

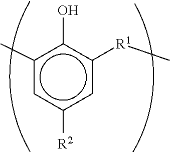

wherein R¹ is a linear or branched alkylen group with 1 to 10 carbon atoms and R² is a linear or branched, saturated or unsaturated aliphatic hydrocarbon group with up to 20 carbon atoms. Preferably, R¹ in formula I is a linear or branched alkylen group with 1 to 4 carbon atoms. In a particularly preferred embodiment of the invention R¹ in formula I is CH₂ or HC—CH₃ or H₂C—CH₂.

Preferably, R² in formula I is a linear or branched, saturated or unsaturated aliphatic hydrocarbon group with 4 to 10 carbon atoms. In a particularly preferred embodiment of the invention R² in formula I is a linear or branched, saturated or unsaturated aliphatic hydrocarbon group with 4 carbon atoms. In a most preferred embodiments R² is para-tertiary-butyl.

Resins with R¹=CH₂ may be obtained by reacting a phenyl compound of formula R²—C₆H₄—OH with formaldehyde. In this reaction formaldehyde adds to a carbon atom of R²—C₆H₄—OH (usually the carbon atom in ortho position to the OH group) followed by reaction of the obtained methylol group with further R²—C₆H₄—OH under elimination of water. The obtained resin may to some extent be crosslinked as further formaldehyde might add to the less reactive meta position.

Resins with R¹=HC—CH₃ or R¹=H₂C—CH₂ may be obtained by reacting a phenyl compound of formula R²—C₆H₄—OH with acetylene. In this reaction acetylene adds to a carbon atom of R²—C₆H₄—OH (usually the carbon atom in ortho position to the OH group) followed by reaction of the obtained vinyl group with further R²—C₆H₄—OH. The obtained resin may to some extent be crosslinked as further acetylene might add to the less reactive meta position.

Most preferred resin is Koresin®, a resin marketed by BASF, and which is obtainable by reacting acetylene and para tertiary butyl phenol.

Koresin® comprises units of formula II

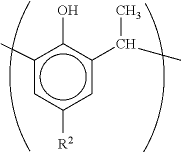

Due to an alternative integration of the acetylene in the reaction Koresin® may further comprise units of formula III

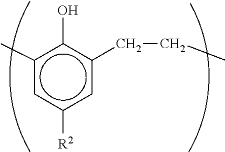

R² in formula II and III is para tertiary butyl.

End groups of the polymeric molecules of Koresin® may in particular be vinyl groups which result from acetylene.

The resin may comprise further structural elements which are incorporated by using comonomers or reactive additives as further starting materials in the reaction.

Preferably, at least 80% by weight of the starting materials used for the preparation of the resin are R²—C₆H₄—OH and formaldehyde (in case of R¹=CH₂) or R²—C₆H₄—OH and acetylene (in case of R¹=HC—CH₃ or R¹=H₂C—CH₂ or mixtures thereof).

In a more preferred embodiment at least 90%, particularly at least 95% by weight of the starting materials used for the preparation of the resin are R²—C₆H₄—OH and formaldehyde (in case of R¹=CH₂) or R²—C₆H₄—OH and acetylene (in case of R¹=HC—CH₃ or R¹=H₂C—CH₂ or mixtures thereof).

In a most preferred embodiment no other starting materials than R²—C₆H₄—OH and formaldehyde (in case of R¹=CH₂) or R²—C₆H₄—OH and acetylene (in case of R¹=HC—CH₃ or R¹=H₂C—CH₂ or mixtures thereof) are used for the preparation of the resin.

### To the Amino Resin

The amino resin is a resin with on average at least two hydroxy or ether groups per molecule.

Preferably, the amino resin is an amino-formaldehyde resin. Such resins are usually obtained by reacting an amino compound, notably urea or melamine, with formaldehyde. A methylolated amino compound is obtained, which may be etherified and may undergo further condensation and crosslinking reactions.

The amino resin, respectively amino-formaldehyde resin, comprises preferably ether groups.

In a particularly preferred embodiment, the amino resin, respectively amino-formaldehyde resin, comprises on average at least two, notably at least three and most preferably at least 4 ether groups per molecule.

The ether groups are preferably alkyl ether groups, specifically C1- to C4-alkylether groups, such as a methyl ether group, an ethyl ether group, an isopropyl- or n-propyl ether group or a n-butyl-, isobutyl or tertiary butyl ether group.

More preferred is a methyl ether group or ethyl ether group. Most preferred is a methyl ether group.

The amino-formaldehyde resin is preferably a melamine-formaldehyde or a urea formaldehyde resin.

Most preferably, the amino-formaldehyde resin is a melamine-formaldehyde resin.

Melamine-formaldehyde resins are obtained by reacting melamine with formaldehyde. The primary amino groups of the melamine become methylolated. At maximum 6 methylol groups per melamine molecule are possible, as each primary amino group may become substituted by two methylol groups. The methylol groups may undergo crosslinking reaction, thus forming compounds with more than one melamine ring. The methylol groups may be etherified by reacting them with an alkanol, notably a C1 to C4 alkanol.

Preferred melamine-formaldehyde resins are those wherein on average at least 50% of the hydrogen atoms of the primary amino groups of the melamine-formaldehyde resin are replaced by methylol groups and at least 50% of such methylol groups are etherified with a C1- to C4 alkyl group.

Preferably, the melamine-formaldehyde resin comprises on average 1 to 3 melamine rings per molecule; more preferably, the melamine-formaldehyde resin comprises on average 1 to 2 melamine rings per molecule. Most preferably, the melamine-formaldehyde resin comprises on average 1 to 1.5, notably 1 to 1.2 melamine rings per molecule.

In a most preferred embodiment, the melamine-formaldehyde, comprises on average at least two, notably at least three and most preferably at least 4 ether groups, notably methyl ether groups, per molecule.

A most preferred melamine-formaldehyde resin is, for example, hexamethoxymethylmelamine.

The amino resin may be used as such or in form of a solution in water or an organic solvent, depending on its solubility.

Preferably, the tackifier comprises 0.5 to 30 parts by weight of the amino resin on 100 parts by weight of the resin with repeating units of formula I. More preferably, the tackifier comprises 2 to 20 parts by weight of the amino resin on 100 parts by weight of the resin with repeating units of formula I. Most preferably, the tackifier comprises 5 to 15, notably 5 to 10 parts by weight of the amino resin on 100 parts by weight of the resin with repeating units of formula I.

### To the Plasticizer

The tackifier may furthermore comprise a plasticizer.

In a preferred embodiment of the invention, the tackifier comprises a plasticizer.

Preferably, the plasticizer is a non-aromatic compound which consists to at least 50% by weight of one or more linear or branched, saturated or unsaturated aliphatic hydrocarbon groups with at least 4 carbon atoms.

More preferably, the non-aromatic compound consists to at least 60% by weight, in particular to at least 70%, respectively at least 80% by weight of linear or branched, saturated or unsaturated aliphatic hydrocarbon groups with at least 4 carbon atoms.

The hydrocarbon groups may preferably be hydrocarbon groups with at least 6 carbon atoms, notably with at least 8 carbon atoms, respectively with at least 10 carbon atoms. Usually, the number of carbon atoms of the hydrocarbon groups will be at maximum 60, notably at maximum 40 and in preferred embodiments at maximum 20.

In a particularly preferred embodiment the non-aromatic compound consists to at least 80% by weight of linear or branched, saturated or unsaturated, aliphatic hydrocarbon groups with from 10 to 60 carbon atoms.

The non-aromatic compound may be a pure hydrocarbon which does not comprise any other chemical elements or functional groups.

The non-aromatic compound may be a hydrocarbon compound comprising one or more hydrocarbon groups and further functional groups. In a preferred embodiment, the further functional groups are selected from groups comprising oxygen or nitrogen atoms.

Preferably, such further functional groups are alcohol groups, primary, secondary or tertiary amino groups, carbonyl groups, such as aldehyde or keto groups, carboxylic acid groups, carboxylic anhydride groups, carboxylic ester groups, carboxylic amid groups or dicarboxylic imide groups.

Preferably, the non-aromatic compound does consist of carbon, hydrogen and optionally of oxygen and nitrogen atoms, only.

In a particularly preferred embodiment the non-aromatic compound does consist of carbon, hydrogen or of carbon, hydrogen and oxygen, only.

In a most preferred embodiment the non-aromatic compound does consist of carbon, hydrogen and oxygen, only.

Preferably, the weight average molecular weight of the non-aromatic compound is from 100 to 2.000 g/mol, in particular from 200 to 1.000 g/mol.

Preferred non-aromatic compounds are
linear or branched, saturated or unsaturated aliphatic hydrocarbons
oligomers obtained by reacting unsaturated aliphatic hydrocarbons with unsaturated dicarboxylic acids, dicarboxylic acid anhydrids or dicarboxylic acid amides
saturated or unsaturated fatty alcohols
saturated or unsaturated fatty acids
esters of saturated or unsaturated fatty alcohols with mono-, di-, tri- or tetra carboxylic acids, including saturated or unsaturated fatty acids
esters of saturated or unsaturated fatty acids with alcohols other than saturated or unsaturated fatty alcohols or
saturated or unsaturated fatty acid anhydrides or amides.

Preferred linear or branched, saturated or unsaturated aliphatic hydrocarbons are hydrocarbons with 6 to 24 carbon atoms which are fully saturated or which have one or two carbon-carbon double bonds. As example octan, octen, decan, decen, dodecan, dodecen etc. may be mentioned.

A preferred oligomer obtained by reacting unsaturated aliphatic hydrocarbons with unsaturated dicarboxylic acids is polyisobutenyl succinic anhydride known as PIBSA. Polyisobutenyl succinic anhydride is, for example, sold by BASF under the trade name Glissopal SA®. Polyisobutenyl succinic anhydride is obtainable by reacting polyisobutylene (which is the polymer of 2-methyl-propen=isobutene) and maleic anhydride. Preferred polyisobutenyl succinic anhydride has a number average molecular weight of from 150 to 3.000 g/mol, in particular from 500 to 1.500 g/mol and has a content of succinic anhydride groups of 0.1 to 3 mol succinic anhydride per 1000 g of polyisobutenyl succinic anhydride.

Preferred saturated or unsaturated fatty alcohols have 6 to 24 carbon atoms, one or two hydroxyl groups and are fully saturated or have one or two carbon-carbon double bonds. As example octanol, decanol, tetradecanol (myristyl alcohol), hexadecanol (cetyl alcohol), octadecanol (stearyl alcohol) may be mentioned.

Preferred saturated or unsaturated fatty acids have 6 to 24 carbon atoms, one or two carboxylic acid groups and are fully saturated or have one or two carbon-carbon double bonds. As example saturated fatty acids such as octanoic acid, decanoic acid, tetradecanoic acid, hexadecanoic acid, octadecanoic acid (stearylic acid) and unsaturated fatty acids such as oleic acid (C18), linoleic acid (C18 with two double bonds) may be mentioned.

Preferred esters of fatty alcohols with mono-, di-, tri- or tetra carboxylic acids are esters of the above mentioned fatty alcohols with acrylic acid, malonic acid, maleic acid, fumaric acid or the above mentioned saturated or unsaturated fatty acids.

Preferred esters of saturated or unsaturated fatty acids with alcohols other than saturated or unsaturated fatty alcohols are esters of the above mentioned fatty acids with low molecular weight alcohols such as ethanol, propanol, iso-propanol, or n-butanol.

Preferred saturated or unsaturated fatty acid anhydrides or amides are anhydrides or amids of the above mentioned fatty acids.

Particularly preferred are fatty acid and fatty alcohols, notably fatty alcohols.

In a preferred embodiment, the tackifier comprises a plasticizer as described above.

More preferably, the tackifier comprises at least 0.1 part by weight, particularly at least 1 part by weight and in a more preferred embodiment at least 2 parts by weight of the plasticizer on 100 parts by weight of the resin of formula I.

Usually, the tackifier does not comprise more than 100 parts by weight of the plasticizer on 100 parts by weight of the resin of formula I.

In a preferred embodiment the tackifier comprises at maximum 50 parts by weight, in a more preferred embodiment at maximum 30 parts by weight of the plasticizer per 100 parts by weight of the resin of formula I.

In a particularly preferred embodiment the tackifier comprises at maximum 15 parts by weight, in a most preferred embodiment at maximum 10 parts by weight of the plasticizer on 100 parts by weight of the resin of formula I.

Preferred are notably tackifiers comprising 0.1 to 50 parts by weight and in a most preferred embodiment 1 to 10 parts by weight of the plasticizer on 100 parts by weight of the resin of formula I.

### Further Components and Properties of the Tackifier

The tackifier may comprise further components. In particular, the tackifier may comprise other resins than those of formula I or additives such as stabilizers of any kind. The tackifier might already comprise additives or components which are required or desired in the application, for example stabilizers for rubber or accelerators which are used for the vulcanization of rubber. In a preferred embodiment the tackifier consists to at least 80% by weight, in a more preferred embodiment to at least 90% by weight and in a particularly preferred embodiment to at least 97% by weight of the resin of formula I, the amino resin and the plasticizer, only. In a most preferred embodiment the tackifier comprises only the resin of formula I, the amino resin and the plasticizer and does not comprise any further components.

Preferably, the tackifier has glass transition temperature of 50 to 120° C., notably between 60 and 110° C., determined by Differential scanning calorimetry (DSC).

Preferably, the tackifier has a melting viscosity of 0.1 to 20 Pas, notably of 0.3 to 18 Pas at 170° C.

Preferably, the tackifier has a melting viscosity of 0.01 to 12 Pas, notably of 0.05 to 10 Pas at 200° C.

### To the Preparation of the Tackifier

The tackifier may be prepared by mixing the resin with repeating units of formula I, the amino resin and—in a preferred embodiment—the plasticizer by any methods known and by adding the components in any sequence or combinations.

Preferably, the amino resin and the plasticizer are added to the melt of the resin. The temperature of the melt, in particular of the molten Koresin, is from 150 to 250° C., in particular from 180 to 230° C. The obtained mixture of the resin with repeating units of formula I, the amino resin and the plasticizer is preferably stirred until a homogeneous distribution of the amino resin and optionally the plasticizer is achieved. Preferably, the obtained mixture is converted into solid granules by pastillation. The granules may be stored or transported for further use of the obtained tackifier.

In a preferred embodiment, the resin and the amino resin and the plasticizer are mixed during or directly after the preparation of the resin. The obtained resin is still in the molten state and can be easily mixed with the amino resin and the optionally used plasticizer.

The melt may be converted into solid granules by pastillation. The granules may be stored or transported for further use of the obtained tackifier.

The obtained tackifier has a reduced content of volatiles, notably of the residual phenol derivative used as starting material. In case of Koresin, the residual phenol derivative is para tertiary butyl phenol. This reduced content results from a chemical reaction of the amino resin with the residual phenol derivative, notably para tertiary butyl phenol in case of Koresin.

Preferably, the content of residual phenol derivative is at maximum 1 part by weight, more preferably 0.5 parts by weight and most preferably 0.2 parts by weight per 100 parts by weight of the tackifier. In a particularly preferred embodiment, the content of residual phenol derivative is at maximum 0.1 part by weight per 100 parts by weight of the tackifier.

The process of this patent application is a chemical process for the removal of volatiles. This chemical process may be combined with a physical process for the reduction of volatiles which is described in unpublished European patent application No. 18154940.3 (INV 171459). In the physical process of unpublished European patent application No. 18154940.3 (INV 171459), volatiles are removed from the melt of the resin with repeating units of formula I, respectively the tackifier, by passing the melt as film through at least one evaporator.

The physical process of unpublished European patent application No. 18154940.3 (INV 171459) may be combined with the chemical process of this patent application in any manner.

The physical process may be applied to the resin with repeating units of formula I before it is mixed with the amino resin and plasticizer. The physical process may also be applied to the tackifier already comprising the amino resin and plasticizer.

Both, the physical and chemical process for the removal of volatiles may be part of a process comprising
preparation of the resin
mixing the molten resin with amino resin and optionally the plasticizer (chemical process for the removal of volatiles) and
passing the obtained molten mixture to the physical process for removal of volatile compounds

or, alternatively,
preparation of the resin
passing the molten resin to the physical process for removal of volatile compounds
mixing the molten resin with amino resin and optionally the plasticizer (chemical process for the removal of volatiles)

In a preferred embodiment, the above processes are performed continuously. Throughout the process steps of the two continuous processes, the resin, respectively the mixture, is preferably kept in the molten state.

Details of the physical process are described in unpublished European patent application No. 18154940.3 (INV 171459), the content of which is herewith incorporated by reference in this patent application.

The physical process is preferably performed at a temperature of the resin, respectively tackifier of from 170 to 230° C. and more preferably of from 190 to 220° C.

Preferably, the physical process is performed under reduced pressure. Preferably, the pressure in the evaporator is 0.1-100 mbar, respectively 0.1 to 50 mbar.

Evaporators for the physical process are any evaporators which are designed for the transport of films. Suitable evaporators are known as thin film evaporators, notably falling film evaporator.

In a preferred embodiment, the thin film evaporator comprises wipers. Such wipers are notably used in shell-and-tube apparatuses. In a preferred design of such a shell-and-tube apparatus, the wipers are fixed to the surface of a rotating inner tube and the film is transported on the inner surface of the exterior cylinder. The wipers come close or in contact with the moving film thus effecting homogeneity of the film and adjustment of the film thickness.

The residence time of the film in the evaporator or—in case of a multistage process—in the evaporators in total may, for example, be 1 second to 30 minutes. Preferably, the residence time is the evaporator or the evaporators in total is 10 seconds to 10 minutes and more preferably 10 seconds to 5 minutes.

### To Rubber Compositions

Preferably, the tackifier is used as tackifier in rubber compositions.

The rubber composition comprises the rubber, the tackifier and optionally further components. The rubber may be any rubber, as well as a natural or a synthetic rubber. Preferably, the rubber is a compound with at least one double bond which can be crosslinked. Natural rubber is a polymer of isoprene.

Synthetic rubber may be, for example, a synthetic polyisoprene, a polybutadiene (BR), a styrene-butadiene copolymer (SBR), an acrylnitril-butadiene copolymer, an ethylene-propylene-diene copolymer or a polychloroprene.

Preferred rubbers are BR or SBR.

In a preferred embodiment, the rubber composition comprises at least 0.1 part by weight, particularly at least 1 part by weight and in a more preferred embodiment at least 2 parts by weight of the tackifier per 100 parts by weight of the rubber.

Usually, the rubber composition does not comprise more than 100 parts by weight of the tackifier per 100 parts by weight of the rubber.

In a preferred embodiment the rubber composition comprises at maximum 50 parts by weight, in a more preferred embodiment at maximum 30 parts by weight of the tackifier per 100 parts by weight of the rubber.

In a particularly preferred embodiment the rubber composition comprises at maximum 15 parts by weight, in a most preferred embodiment at maximum 10 parts by weight of the tackifier per 100 parts by weight of the rubber.

Preferred are in particular rubber compositions comprising comprises 0.1 to 50 parts by weight and in a most preferred embodiment 1 to 10 parts by weight of the tackifier per 100 parts by weight of the rubber.

The rubber composition may comprise further additives. In particular, rubber compositions usually comprise a vulcanization agent such as elementary sulfur and an accelerator for the vulcanization, such as, for example, zinc oxide or benzothiazol sulfonamides and in particular N-cyclohexyl-2-benzothiazole sulfonamide (CBS).

Other additives are notably fillers and pigments, for example carbon black and silica.

The rubber composition may be prepared according to standard mixing procedures, for example by kneading the components such as rubber, tackifier, vulcanization agent and optionally accelerator, pigments and others in as standard equipment like a Banbury mixer.

Preferred is a process for the preparation of a rubber compositions wherein the tackifier is added as melt to rubber. During the addition of the tackifier of the rubber is kept preferably at a temperature from 60 to 150° C., particularly preferred is a temperature of the rubber from 80 to 120° C.

The rubber composition may be used for the manufacturing of rubber articles. In the manufacturing process the rubber compositions, respectively the parts made therefrom, may be vulcanized as usual. Preferred rubber products obtained are in particular tires for cars or trucks. The rubber articles are finally formed by vulcanization, which is usually performed at elevated temperatures.

In the production of rubber products a certain number of non-vulcanized rubber parts prepared from the same or different rubber composition are put together to form a desired rubber composite. The rubber parts should have a high adhesion and stick to each other strongly. In the next step the rubber composite is vulcanized at high temperatures. In vulcanization the rubber becomes crosslinked, the rubber parts become strongly bonded to each other and the final rubber product with good mechanical properties, for example a tire, is formed.

The products made from the rubber composition may in particular be composites that comprise other materials, for example reinforcing materials, in particular steel cords which are covered by the vulcanized rubber composition.

The tackifier of this invention has a low content of volatile compounds, notably of residual phenol derivative used as starting material, for example para tertiary butyl phenol in case of Koresin. Rubber compositions comprising the tackifier have high tackiness which allows the manufacturing of rubber products, in particular tires, with high performance, in particular with very good mechanical properties such as a high stability and stiffness.

### EXAMPLES

### Materials Used:

Resin with Repeating Units of Formula I

### Koresin® of BASF

Koresin is a resin which is obtainable by reacting acetylene and para tertiary butyl phenol.

### SP 1068:

An alkyl-phenol-formaldehyde resin obtained by reacting para tertiary butyl phenol and para tertiary octyl phenol with formaldehyde (marketed by SI Group)

### PF 7001:

An alkyl-phenol-formaldehyde resin obtained by reacting para tertiary butyl phenol with formaldehyde (marketed by Shandong Laiwu Runda)

### SC 204:

An alkyl-phenol-formaldehyde resin obtained by reacting para tertiary butyl phenol with formaldehyde

### Amino Resin:

The following melamine-formaldehyde resins (shortly MF resins) have been used:

### MF 1:

a melamin-formaldehyde resin with 5.7 methylol groups per melamine, whereby 4.7 methylol groups per melamine are etherified with methanol

### MF 2:

a melamin-formaldehyde resin with 4.1 methylol groups per melamine, whereby 3.0 methylol groups per melamine are etherified with methanol

For comparison, paraformaldehyde was used as an alternative to melamine-formaldehyde resins

### Plasticizer

1-Octadecanol (shortly “Octa” in some tables) has been used as plasticizer.

### Preparation of the Tackifier:

Koresin® (200 g), optionally the plasticizer 1-octadecanol and the melamine-formaldehyde resin were placed in a flask equipped with a condenser and mechanical stirrer and heated to 180° C. The Mixture was then stirred for one hour and then cooled down. After the melt had cooled down and solidified the material was removed and analyzed via GC (to determine the content of tertiary butylphenol, shortly tBP), GPC (to determine the number average molecular weight Mn, the weight average molecular weight Mw and the polydispersity PD, tetrahydrofuran used as solvent) and DSC (Differential scanning calorimetry, heating rate 10K/min up to 200° C.). The glass-transition temperatures (Tg) were derived from the DSC data.

### Tackifiers 1-4

Further tackifiers 2 to 4 have been prepared and analyzed according to the procedure described above. Tackifier 1 is simply Koresin.

Table 1 shows the compositions of the tackifiers and table 2 some analytical data of the tackifiers

TABLE 1
compositions of the tackifiers

| | Koresin | 1-octadecanol | MF 1 |
|---|---|---|---|
| tackifiers | parts by weight | parts by weight | parts by weight |
| 1 | 100 | | |
| 2 | 100 | 7 | 3 |
| 3 | 100 | 10 | 6 |
| 4 | 100 | 10 | 9 |

TABLE 2
analytical data of the tackifiers

| | content of | Mn, | Mw, | | Tg, |
|---|---|---|---|---|---|
| tackifiers | tBP % | g/mol | g/mol | PD | ° C. |
| 1 | 1.33 | 1222 | 2016 | 1.7 | 99 |
| 2 | 0.21 | 1654 | 3046 | 1.8 | 98.3 |
| 3 | 0.09 | 1832 | 4495 | 2.5 | 98.3 |
| 4 | 0.04 | 2108 | 7507 | 3.6 | 108.6 |

### Determination of Tackiness

A rubber formulation with the following composition (in parts by weight) was used:

| | |
|---|---|
| SBR rubber | 100 |
| Process oil | 13 |
| Carbon black | 45 |
| Talc | 17 |
| Polybutadiene | 17 |

The above rubber formulation was compounded on a roller mill with 5 parts by weight of the samples od table 1. After the addition of the tackifier the temperature of the mixture was raised to 120° C. for 3 minutes to ensure a homogenous dispersion of the resin.

Test samples prepared from the finished compound were stored at 23° C. and a relative humidity of 50% for the times given in Table 2.

The tack of the test samples was determined after different storage times as listed in Table 3.

In particular, the tack of these samples was measured with a “Ketjen Tackmeter”. Two test samples which had the form of strips are pressed together with a force of 20 N/cm² for 30 seconds. Between the samples there was a Teflon foil with a window to ensure a defined contact area. After release of the force and another 10 seconds for relaxation the strips were separated. The force to separate the two rubber strips from each other was measured in newton (N). A high force corresponds to a high tackiness of the test samples.

TABLE 3
tack

| Storage | tackifier 1 | | | |
|---|---|---|---|---|
| (days) (Tage) | (Koresin, Only) | tackifier 2 | tackifier 3 | tackifier 4 |
| 0 | 21.70 | 18.35 | 26.30 | 19.30 |
| 1 | 35.85 | 33.00 | 30.10 | 32.40 |
| 3 | 23.65 | 17.10 | 19.50 | 22.50 |
| 6 | 16.48 | 16.60 | 17.70 | 15.90 |
| 10 | 13.05 | 12.30 | 13.40 | 10.40 |

### Tackifiers 5 to 11

Further tackifiers 5 to 11 have been prepared and analyzed according to the procedure described above; however, Koresin has been replaced by other commercially available resins with repeating units of formula I.

TABLE 4
composition and analytical data of the tackifiers

| | composition | | | | | | | | |
|---|---|---|---|---|---|---|---|---|---|
| | alkylphenol- | Octa | MF 1 | | | | | | |
| | formaldehyd | parts | parts | tBP | | | | | Tg |
| Tackifier | resin | by weight | by weight | % | tOP | Mn | Mw | PD | ° C. |
| 5 | SP 1068 | | | | 3.7 | 870 | 1428 | 1.6 | 52.0 |
| 6 | SP 1068 | 7 | 6 | 0.07 | 1.75 | 1652 | 4033 | 2.4 | 57.6 |
| 7 | PF 7001 | | | 1.8 | | 1165 | 1850 | | 102.0 |
| 8 | PF 7001 | 9 | 5 | 0.14 | | 1580 | 3540 | 2.2 | 90.2 |
| 9 | SC 204 | | | 3.07 | | | | | 84.0 |
| 10 | SC 204 | 9 | 5 | 0.54 | | 1414 | 2259 | 1.6 | 101.1 |
| 11 | SC 204 | 9 | 9 | 0.39 | | 3442 | 3442 | 1.9 | 112.5 |

tOP: tertiary octyl phenol
TBP: tertiary butyl phenol
The parts by weight of Octadecanol and MF 1 are based on 100 parts by weight of the alkylphenol-formaldehyde resin

### Tackifiers 12 to 16

Further tackifiers 12 to 16 have been prepared and analyzed according to the procedure described above. However, no plasticizer (1-octadecanol) has been used and the components have been heated to 200° C. instead of 180° C. All tackifiers are based on Koresin; the parts by weight of the amino resin is based on 100 parts by weight of Koresin.

TABLE 5
composition and analytical data of the tackifiers

| | Koresin, | | Parts by weight | | |
|---|---|---|---|---|---|
| | parts by | Amino resin | of amino resin | | Tg |
| tackifiers | weight | or other resin | or other resin | tBP % | ° C. |
| 12 | 100 | MF1 | 3 | 0.27 | 131.0 |
| 13 | 100 | MF1 | 5 | 0.09 | 138.5 |
| 14 | 100 | MF1 | 7 | 0.05 | 150.4 |
| 15 | 100 | MF2 | 3 | 0.40 | 124.6 |
| 16 | 100 | Para- | 5 | 0.83 | 132.3 |
| | | formaldehyd | | | |

### Tackifiers 17 to 23

Further tackifiers 17 to 23 have been prepared and analyzed according to the procedure described above. However, the reaction temperature has been varied between 180 and 230° C. and the reaction time has been varied between 1 and three hours.

TABLE 6
composition and analytical data of the tackifiers

| | Reaction | Reaction | | | | |
|---|---|---|---|---|---|---|
| tack- | Temp | time | Octadecanol | MF1 | tBP | Tg |
| ifier | (° C.) | (h) | (%) | (%) | % | ° C. |
| 17 | 200 | 1 | 3 | 5 | 0.07 | 129.0 |
| 18 | 230 | 2 | 3 | 5 | 0.25 | 98.0 |
| 19 | 200 | 1 | 5 | 5 | 0.08 | 116.9 |
| 20 | 230 | 3 | 5 | 5 | 0.25 | 110.3 |
| 21 | 200 | 1 | 5 | 7 | 0.04 | 118.3 |
| 22 | 230 | 3 | 5 | 7 | 0.25 | 106.5 |
| 23 | 180 | 1 | 7 | 9 | 0.02 | 105.9 |

Tackifiers 1, 5, 7, 9 and 16 are for comparison.

1: A tackifier, comprising:
a resin with repeating units of formula I 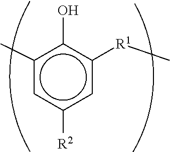
wherein R¹ is a linear or branched alkylene group with 1 to 10 carbon atoms and R² is a linear or branched, saturated or unsaturated aliphatic hydrocarbon group with up to 20 carbon atoms, and
an amino resin with on average at least two hydroxy or ether groups per molecule.

2: The tackifier according to claim 1, wherein R¹ in formula I is CH₂, HC—CH₃, or H₂C—CH₂.

3: The tackifier according to claim 1, wherein R² in formula I is a linear or branched, saturated or unsaturated aliphatic hydrocarbon group with 4 to 10 carbon atoms.

4: The tackifier according to claim 1, wherein the resin with repeating units of formula I is a resin which is obtainable by reacting acetylene and para tertiary butyl phenol.

5: The tackifier according to claim 1, wherein the amino resin is an amino resin with on average at least two ether groups per molecule.

6: The tackifier according to claim 1, wherein the amino resin is an amino resin with on average at least two methyl ether groups per molecule.

7: The tackifier according to claim 1, wherein the amino resin is a melamine-formaldehyde resin.

8: The tackifier according to claim 7, wherein the melamine-formaldehyde resin comprises on average 1 to 3 melamine rings per molecule.

9: The tackifier according to claim 1, wherein the tackifier comprises 0.5 to 30 parts by weight of the amino resin per 100 parts by weight of the resin with repeating units of formula I.

10: The tackifier according to claim 1, wherein the tackifier comprises a plasticizer.

11: The tackifier according to claim 10, wherein the plasticizer is selected from the group consisting of
a linear or branched, saturated or unsaturated aliphatic hydrocarbon;
an oligomer obtained by reacting an unsaturated aliphatic hydrocarbon with an unsaturated dicarboxylic acid, a dicarboxylic acid anhydride, or a dicarboxylic acid amide;
a saturated or unsaturated fatty alcohol;
a saturated or unsaturated fatty acid;
an ester of a saturated or unsaturated fatty alcohol with a mono-, di-, tri- or tetra carboxylic acid, including a saturated or unsaturated fatty acid;
an ester of a saturated or unsaturated fatty acid with an alcohol other than a saturated or unsaturated fatty alcohol; and
a saturated or unsaturated fatty acid anhydride or amide.

12: The tackifier according to claim 10, wherein the tackifier comprises 0.1 to 50 parts by weight of the plasticizer per 100 parts by weight of the resin with repeating units of formula I.

13: A rubber composition, comprising the tackifier according to claim 1.

14: The rubber composition according to claim 13, wherein the rubber composition comprises 0.1 to 50 parts by weight of tackifier per 100 parts by weight of rubber.
